(19) United States
(12) Patent Application Publication
(10) Pub. No.: US 2025/0078073 A1
(43) Pub. Date: Mar. 6, 2025

(54) SYSTEMS AND METHODS FOR USE IN PROVIDING SERVICES ACROSS MULTIPLE REGIONS

(71) Applicant: MASTERCARD INTERNATIONAL INCORPORATED, Purchase, NY (US)

(72) Inventors: Peter Groarke, Dublin (IE); Annie Sandesh Kudtarkar, Pune (IN); Jaydeep R. Rajput, Pune (IN); Peter Julian Reyes Flor, O'Fallon, MO (US)

(21) Appl. No.: 18/240,119

(22) Filed: Aug. 30, 2023

(51) Int. Cl. G06Q 20/40

(52) U.S. Cl. CPC G06Q 20/401

(57) ABSTRACT

Systems and methods are provided for providing a service across multiple regions. One exemplary computer-implemented method includes receiving, by a switch interface computing device, a service request from a client, via a service, where the switch interface computing device located in a first region, and then determining a second region, based on the service request and at least one rule. The method also includes, based on the determined second region, directing, by the switch interface computing device, the service request to a switch located in the second region and transmitting, by the switch interface computing device, to the service, an indication of the second region, whereby the service is informed the service request is to proceed in the second region.

### FIELD

The present disclosure generally relates to systems and methods for use in providing on-behalf-of services across multiple regions.

### BACKGROUND

This section provides background information related to the present disclosure which is not necessarily prior art.

Users are known to hold accounts with different parties. The parties may, from time to time, post transactions to the accounts, consistent with one or more services of the accounts. For example, a transaction may be posted to a user's account as a redemption of benefits associated with the account (e.g., loyalty, etc.). In connection with the transaction, the transaction is posted to a clearing service of a network, whereby the centralized clearing service imposes the transaction on accounts involved in the transaction (e.g., a source account, a recipient account, etc.).

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in providing on-half of services across multiple regions;

FIG. 2 is a block diagram of an example computing device that may be used in the exemplary system of FIG. 1; and

FIG. 3 is an exemplary method that may be implemented in the system of FIG. 1 for providing a service, on behalf of an upstream client, to users across multiple regions.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Processing networks provide access to various services, some of which are on-behalf-of services for certain clients. Of those services, some are related to direct fund transfers, which are directed to clearing services. The fund transfers, consequently, are not provided to the processing network through conventional four-party schemes. Processing networks often provide the services on a global scale, from a centralized location. The advent of regional restrictions on exchanges of data, and the performance of such services, has limited usability of the centralized services.

Uniquely, the systems and methods herein provide a de-centralized scheme for providing services across multiple regions. In particular, switch interfaces are implemented as part of a processing network in various regions, whereby one or more rules are imposed, and service requests are received and then routed, based on the one or more rules, to a specific switch in a specific region. The one or more rules define applicable privacy concerns, data regulations and/or law, and/or preferences, etc., to provide for a multi-region capability of the processing network. In this manner, the switch interfaces act to push service requests into a switch and a region for processing the service request based on the one or more rules (e.g., based on the initiator, recipient, currency, etc., of the service request, etc.), whereby the processing of service request is decentralized to the region to which the service request is implicated. As such, network efficiency is enhanced, through use of the switch interface to impose the one or more rules while obviating the requestors of services from responsibility for routing decisions as it relates to service requests across multiple regions.

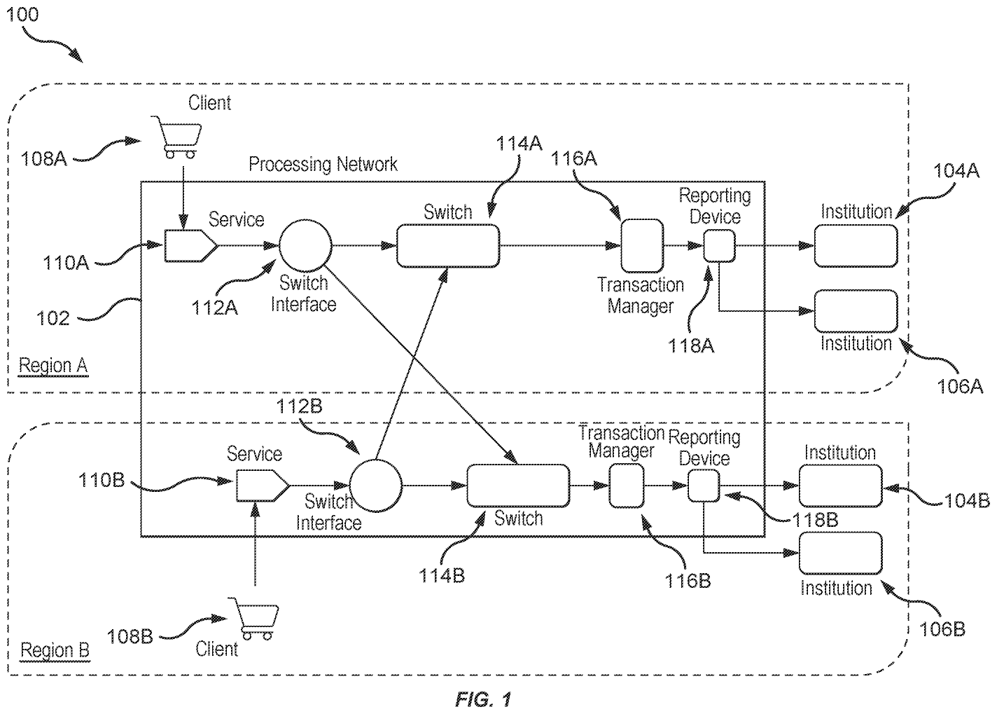

FIG. 1 illustrates an exemplary system 100 in which one or more aspects of the present disclosure may be implemented. Although the system 100 is presented in one arrangement, other embodiments may include systems arranged otherwise depending, for example, on processing schemes, privacy rules and regulations, etc.

In the illustrated embodiment, the system 100 generally includes a processing network 102, which is configured to process each of multiple transactions between different accounts issued by various institutions. A transaction (of the multiple transactions) may be defined between a user, a merchant, and the institutions, whereby the transaction is authorized, cleared and settled. In addition, in this exemplary embodiment, the processing network 102 is configured to provide one or more services for clients to introduce fund transfers directly to the processing network 102, such as, for example, rebate services, bonus services, and/or send services (e.g., send funds from one party to another, etc.), etc.

As shown in FIG. 1, the processing network 102 is disposed in Region A and Region B, and potentially, various other regions. The regions may be defined by geographical, political, or sovereign borders, or otherwise, where each region is associated with one or more rules related to the processing of data related to a user and/or a transfer. Example regions may include parts of countries (e.g., states, territories, etc.), countries (e.g., United States, Sweden, South Africa, etc.), groups of countries (e.g., European Union, etc.), or other regions based on rules, regulations, agreements, treaties, etc., or combinations thereof.

It should be appreciated that the processing network 102 may extend into still other regions, whereby the processing network 102 may be disposed in any number of regions.

It should be further appreciated that the processing network 102, in Region A, generally refers to a computing device being physically disposed in Region A. In this manner, the computing device in Region A (or any of the other regions) is considered to be in that region for purposes of data rules, limitations, and/or regulations related to local control and/or processing of the data relevant to a service request.

The system 100 includes an acquiring institution 104A and an issuer institution 106A in Region A and also an acquiring institution 104B and an issuer institution 106B in Region B. It should be appreciated that other systems generally include multiple different acquiring institutions and multiple different issuer institutions. The acquiring institution 104, generally, includes a bank or other financial institution, which is configured to issue accounts to clients (e.g., the client 108A or the client 108B, etc.), as the source of the fund transfers of the one or more of the services offered by the processing network 102. The issuer institution 106, likewise, generally, includes a bank or other financial institution, which is configured to issue accounts to users and which include, for example, credit accounts, debit accounts, prepaid accounts, etc. The accounts issued by the issuer institutions 106, in this embodiment, are generally the recipient accounts of the fund transfer (or chargeback), via the one or more of the services offered by the processing network 102.

The clients 108A and 108B may include any party, which enrolls in the one or more services of the processing network 102 to transfer funds, in connection with the service, to one or more users (not shown). For example, the client 108A may be a merchant, which is configured to issue a rebate to a recipient user, and to do so, may submit a service request to the processing network 102 consistent with the same.

It should be understood that the arrowed lines from the client 108 to the processing network 102, internal to the processing network 102, and also to/from the institutions 104, 106 are representative of one or more networks therebetween, whereby each is coupled in communication. The one or more networks may include, without limitation, a local area network (LAN), a wide area network (WAN) (e.g., the Internet, etc.), a mobile network, a virtual network, and/or another suitable public and/or private network capable of supporting communications among two or more of the parts illustrated in FIG. 1, or any combination thereof.

With continued reference to FIG. 1, the processing network 102 is disposed in each of Region A and Region B. In Region A, as shown, the processing network 102 includes a service 110A, a switch interface 112A, a switch 114A, a transaction manager 116A and a reporting device 118A. In Region B, likewise, as shown, the processing network 102 include a service 110B, a switch interface 112B, a switch 114B, a transaction manager 116B, and a reporting device 118B. Each of the parts of the processing network 102, in each region, as listed directly above generally are configured and/or operate the same in their respective regions. Region A and its parts are described below in detail for purposes of illustration, but the detailed description should be understood to be applicable to the parts of Region B (subject to the difference in region).

In particular, the service 110A is configured to receive service requests from one or more clients (e.g., the client 108A, etc.). The service 110A, in this exemplary embodiment, includes a service application, which is configured to transfer money from a client (e.g., client 108A, etc.) of the processing network 102 to a recipient user (not shown). The service 110A may specifically include a loyalty application, which is configured to execute loyalty rebates. The service 110A is configured as a gRPC client in this exemplary embodiment to communicate with the switch interface 112A of FIG. 1, which includes a request/response protocol. The specific message may include a 1240 message, or a 1220 message, within the International Organization of Standardization (ISO) 8583 standard for interchange messaging, etc. It should be understood that the service 110A may be configured to receive request, in a message, or multiple requests (e.g., in the form of a batch file, etc.), either consistent with gRPC or other suitable framework. Other specific implementations of the services may include, for example, services relating to money sending, rebates, loyalty, rewards, reimbursements, charge disputes (e.g., chargebacks on behalf of an issuer, etc.), etc. It should be appreciated that while only one service 110A is illustrated in Region A, multiple services may be included in other system embodiments, whereby each is limited by type of service, client, etc.

It should ne appreciated, from the description herein, that the processing network 102 may be responsive to single message schemes, or dual message schemes, as appropriate for the specific service(s).

It should further be appreciated that while the client 108A (as the funder) is the requestor in the embodiment described above, the institutions 104A, 106A or another party may be the requestor in various other embodiments. For example, where a chargeback service is requested, the request may originate at the associated issuer institution 106A, etc.

The service request generally includes the details of the transfer, which may include, without limitation, an account number of the account of the client 108A (i.e., as issued by the acquiring institution 104A), a name of the client 108A, an amount, an account number of an account of the recipient user (as issued by the issuer institution 106A), a name of the recipient user, a currency code, or other suitable data. Upon recipient of the service request, the service 110A is configured to direct the service request to the switch interface 112A.

In response, the switch interface 112A (which also may be referred to as an edge node) is configured to apply one or more rules to the service request to determine, for example, a region in which the transfer is to be processed. This may include, for example, identifying the source/initiator of the request, or more specifically, the region of the source/initiator of the request or the service, etc. In this example, the one or more rules are configured to examine the account number of the account of the client 108A (e.g., the account number being within a range of account numbers (e.g., indicative of the region), etc.) and/or the currency code to identify the region of the client 108A, etc. In particular, the one or more rules are defined to determine whether the request is responder-homed or initiator-homed. When the request is responder-homed, the rule(s) define the region in which the responder to the request is located (e.g., the region in which the issuer institution of the account for the user recipient is located for a transaction, etc.) (e.g., 0100/0200 interactive messages for the ISO 8583 standard, etc.). Conversely, where the request is initiator-homed, the rule(s) define the region in which the initiator is located (e.g., the region in which the acquiring institution of the account from which the funds of the rebate are from is located, etc.) Additionally, or alternatively, the one or more rules are configured to examine the account number of the account of the recipient user and/or the currency code to identify the region of the recipient user.

Example rules may rely on specific content from the request. For example, for a 1240 presentment message, the switch interface 112A may be configured to access DE94, Transaction Originator Institution ID, to determined the region of the initiator (e.g., in an initiator-homed request, etc.) and to apply rule(s) related thereto the identify the region. Similarly, for a 1220 message, the switch interface 112A may be configured to access either DE33 or DE32, which is the acquirer institution identifier, and to apply rule(s) related thereto to identify the region.

It should be appreciated that the rules may be different in different regions and/or in different switch interfaces 114. It should also be appreciated that the one or more rules may be updated at one or more intervals, in one region or multiple region, for example, based on the status of the institutions 104A (and/or 104B), 106A (and/or 106B), etc. In this manner, the routing of the request is dependent on the rules, which are decoupled from the specific client 108A and/or service 110A, etc.

In general, the one or more rules define the switch, in the system 100, either switch 114A or switch 114B, in this example embodiment, which is to process the transfer. The switch interface 112A is configured to identify the switch 114 based on the rules and to transmit the service request (in whole or in part) to the switch 114 for processing. In this manner, the switch interface 112A is configured to transmit the service request to either of the switches 114A and 114B, depending on the one or more rules.

In addition to the above, in one or more embodiments, the acquiring institution 104 and the issuer institution 106 may be classified as type I or type II, where type I may include a legacy scheme (e.g., a conventional centralized scheme, etc.) and type II may include a modern scheme. Regardless of legacy or modern, the different types of institutions may indicate a different handling of the service request, as it relates to form or format or processing. For example, the switch interface 112A may be configured to determine the type of the acquiring institution 104A is type I, and on that basis, to direct the service request to a clearing service outside of what is illustrated in FIG. 1 (e.g., a legacy clearing and settlement system, etc.). The same switch interface 112A may be configured to determine the type of the acquiring institution 104B is type II, and on that basis, to direct the service request to the switch 114B (as appropriate).

Moreover, in this exemplary embodiment, the switch interface 112A is configured to translate the service request in one or more manners, prior to transmitting the service request to the switch 114. The translation may be for the format of the message and/or the protocol of the message. For example, the service request may be received as an ISO 1220 message and translated to an ISO 8583 message. In another example, the switch interface 112 may be configured to translate the message from TCP IP or a Remote Procedure Call (RPC) protocol to an event based protocol, etc. In general, the switch interface 112A may be configured to translate a service request from any permitted form, format, protocol, etc., to a form, format, protocol, etc., to be accepted by the switch 114.

In addition, the switch interface 112A is configured to further acknowledge the request, whereby the client 108A is informed of the region in which the request is to be processed. That is, the switch interface 112A is further configured to indicate to the service 110A to which switch 114 the request is transmitted for process, in order to inform the service 110A where to seek and/or expect messaging (e.g., response, etc.) related to status and/or processing of the transfer.

Upon receipt of the service request, the switch 114A is configured to impose the transfer from the account of the client 108A to the account of the recipient user. In connection therewith, the switch 114A is configured to perform a number of different operations, such as, for example, validating the service request from the switch interface 112A (or switch interface 112B when received therefrom) and augmenting the data in the service request with additional data as necessary (e.g., about the issuer institution 106A, etc.). The switch 114A is further configured to apply one or more rules to the transfer, to ensure that the transfer defined by the service request is permissible (e.g., from a fraud monitoring perspective, regulation perspective, etc.). The switch 114A is further configured to inform the transaction manager 116A of the transfer.

In turn, the transaction manager 116A is configured to capture the data related to the transfer and to initiate clearing of the transfer, whereby the transfer is entered to the respective institutions running total for the clearing cycle (e.g., the acquiring institution 104 and the issuer institution 106, etc.). This clearing may be initiated at one or more intervals, or immediately, relative to the service request, or relative to a clearing cycle, etc. The transfer amount entered therein may include the amount of the transfer and any one or more fees that is/are applicable. The transaction manager 116A is configured, in short, to record the life cycle of the transfer within the processing network 102. In connection therewith, the transaction manager 116A is configured to notify the reporting device 118A at one or more intervals relative to the transfer (e.g., immediately, etc.), or relative to a clearing cycle, etc. In turn, the reporting device 118A is configured to notify the acquiring institution 104A and the issuer institution 106A involved in the transfer, whereby each is configured to internally reconcile the transfer (e.g., at one or more intervals, immediately, etc.) to ensue the account of the client 108A is debited for the amount and any fees and the recipient user account is credited for the amount.

In this manner, the processing network 102 may provide for real time transfers, pursuant to the service request, whereby funds are immediately available to the recipient. Real time, as used herein, may refer to within less than a second, a few seconds, or up to a minute, etc.

In connection with the above, the transaction manager 116A is configured to notify the service 110A (or service 110B) of one or more statuses of the transfer, including, for example, completion, clearing settlement, etc.

Thereafter, or at the same time, or in connection therewith, the processing network 102 further includes a settlement facilitator (not shown). The transaction manager 116A is configured to inform the settlement facilitator, in connection with clearance, of amounts to be transferred among the institutions (e.g., per transfer, batch, etc.). The settlement facilitator, in turn, then, is configured to consume the messaging from the transaction manager 116A, to assess the transfer including fees owed, and to facilitate the transfer among the institutions as to amounts to send and/or notifications of what they will receive. The transfer/transaction is then complete.

While the above description, again, is directed to the processing network 102 in Region A, the description is applicable to each of the specific parts of the processing network 102 in Region B. In this manner, the switch interface 112A is configured to transmit, as indicated by the applicable rules, a service request to the switch 114B in Region B, while the switch interface 112B is configured to transmit, as indicated by the applicable rules, a service request to the switch 114A in Region A, whereby each is processed, as indicated above, by the respective switch.

It should be further understood that any number of regions (and switch interfaces, switches, etc.) may be included in the system embodiment, whereby the switch interfaces 112 may be configured to transmit the service request to any number of switches in the number of regions. In this manner, the transfers, which are originated from the services 110, are processed within a specific region, which is defined by one or more rules, despite (or independent of) the region in which the service request is submitted, whereby restrictions associated with the processing of such transfers are obeyed. It should be further appreciated that the switch interfaces 112 may be configured to receive requests from multiple different services, associated with the same or different clients, institutions, etc. In this manner, the switch interfaces 112 may be configured, as above, to interface and apply rules to requests from various different services.

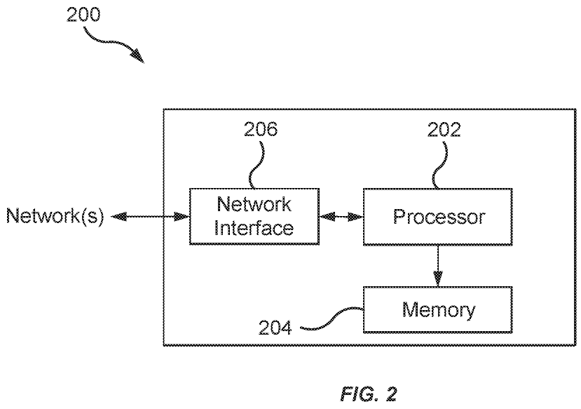

FIG. 2 illustrates an exemplary computing device 200 that can be used in the system 100. The computing device 200 may include, for example, one or more servers, workstations, personal computers, laptops, tablets, smartphones, POS devices, etc. In addition, the computing device 200 may include a single computing device, or it may include multiple computing devices located in close proximity or distributed over a geographic region, so long as the computing devices are specifically configured to function as described herein. In particular, in the exemplary system 100 of FIG. 1, each of the processing network 102 (and parts thereof), acquiring institutions 104, the issuer institutions 106, the clients 108, the services 110, the switch interfaces 112, the switches 114, the transaction managers 116, and/or the reporting devices 118 may include, or may be implemented in, a computing device such as the computing device 200. That said, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transfer/transaction data, currency codes, identifiers, account numbers, rules, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein (e.g., one or more of the operations of method 300, etc.) and thereby cause the processor 202 to operate in a unique and specific manner, for example, to achieve the practical application(s) associated with the performance of such operations. It should be appreciated that the memory 204 may include a variety of different memories, each implemented in one or more of the functions or processes described herein.

In addition, the illustrated computing device 200 also includes a network interface 206 coupled to (and in communication with) the processor 202 and the memory 204. The network interface 206 may include, without limitation, a wired network adapter, a wireless network adapter (e.g., a near field communication (NFC) adapter, a Bluetooth adapter, etc.), a mobile network adapter, or other device capable of communicating to/with one or more different networks (e.g., as indicated by the arrowed lines in FIG. 1, etc.). Further, in some exemplary embodiments, the computing device 200 may include the processor 202 and one or more network interfaces (including the network interface 206) incorporated into or with the processor 202.

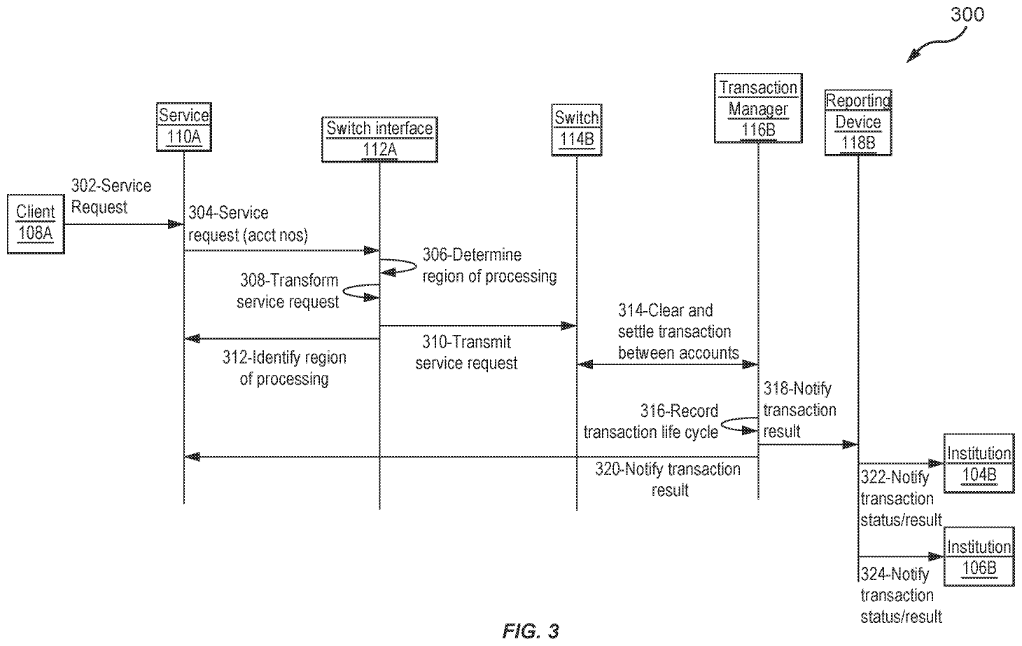

FIG. 3 illustrates an exemplary method 300 for use in providing a service, on behalf of an upstream client, to users across multiple regions. The exemplary method 300 is described with reference to the system 100, and in particular to the processing network 102 thereof, etc. Further reference is also made to the computing device 200. However, it should be understood that the methods herein are not limited to the system 100 or the computing device 200, as the method 300, for example, may be implemented, at least in part, in other parts of the system 100 or in other suitable systems, or in multiple other computing devices. Likewise, the systems and the computing devices herein should not be understood to be limited to the exemplary method 300.

At the outset in the exemplary method 300, the client 108A decides to offer a rebate to one or more users, including a recipient user. In connection therewith, the client 108A decides an amount of the rebate and identifies the account of the recipient user to which the rebate is to be directed. The rebate may be, for example, related to the recipient users' loyalty to the client 108A, which may be a merchant, etc. In this example, the client 108A decides to direct $10 USD to the recipient user and identifies the recipient user's account by the account number ########-####-1234. The client 108A, as shown in FIG. 1, is in Region A. As such, the client 108A directs a service request, at 302, to the service 110A, in Region A, which includes the account number for the recipient user, the amount (i.e., $10 USD) and an account number for the funding account of the client 108A, which, in this example, is issued by the acquiring institution 104B, in Region B.

Upon receipt of the service request, the service 110A submits, at 304, the service request to the switch interface 112A.

In turn, the switch interface 112A determines, at 306, the region of processing of the transaction or transfer of the funds from the account of the client 108A to the account of the recipient user. In dosing so, the switch interface 112A applies one or more rules, which define the region of processing based on the data included in the service request. In this example, the switch interface 112A inspects the account number for the client 108A, which includes a segment (e.g., a bank identification number (BIN), etc.) that is indicative of Region B.

Alternatively, or in addition to the account number, the switch interface 112A may rely on an acquirer identifier (e.g., a numeric or alpha-numeric identifier specific, unique to the acquiring institution 104B, etc.), which is also included in the service request. In still another example, the rules may rely on the client identifier or name, the transaction amount, the date/time of the transaction, or combinations thereof, as indicated in the service request, as a basis to determine the region of processing. The switch interface 112A may further consider a currency code for the transaction, i.e., USD, which is also indicative of Region B in this example.

It should be appreciated that the region of the issuer institution, the acquiring institution, the currency, and also, potentially, the region of the client, etc., and other data may be included in rules to define not only the region of processing, but also the region of storing of the transfer. For example, where the acquiring institution is in Region A (e.g., as indicated by the ICA identifier, acquirer reference number, etc.), the issuer institution is in Region A (e.g., as indicated by the PAN of the recipient user account, or institution identifier, etc.), and the currency is consistent with Region A, the rule(s) may define processing and storing in Region A, but permit storing copies of the transfer in other regions. In another example, where the issuer institution is in Region B, the rule(s) may define processing and storing in Region B and a restriction from storing the transfer in any other region. It should be appreciated that these rules, and other rules may be affected by regulation in the particular regions, or by agreements with institutions involved in the transfer, etc.

It should be appreciated, in general, however, that the rules may define, based on the above data, the location of processing, storing, restricting, permissible access/storing, etc., whereby the switch interface 112A, in this example, is compelled to abide by the rules in advancing the transfer, whether in single or dual message schemes, etc.

In connection with determining the region of processing (e.g., before, at the same time, or after), the switch interface 112A (optionally, as needed) transforms, at 308, the service request to a form, format, or protocol accepted by the switch 114A and/or switch 114B. In this example, the service request is received, from the client 108A, in a gRPC protocol, which the switch interface 112A transforms to an event driven protocol, which is used internal to the processing network 102. It should be appreciated that various transformations may be performed by the switch interface 112A, in this example, to ensure proper receipt and/or conformance to expectations of the switch 114A and/or the switch 114B.

In at least one embodiment, the switch interface 112A transforms the service request, at 308, to a form, format or protocol, based on the determined region of processing and/or the switch in that region (e.g., the switch 114B in Region B, etc.).

At 310, the switch interface 112A transmits the service request (as transformed, if applicable) to the switch 114B in the region determined to be the region of processing by the switch interface 112A. Additionally, the switch interface 112A identifies, at 312, the region of processing of the transaction back to the service 108A, in an acknowledgement of the service request, whereby the service 108A is informed of which specific transaction manager is to be responsible for managing/recording the transaction.

Upon receipt of the service request, at 314, the switch 114B cooperatives with the transaction manger 116B, to initiate clearing and settlement of the transfer/transaction, as described above, which in effect debits the amount of the transaction (plus any applicable fees) from the account of the client 108 (issued by the acquiring institution 104B) and credits the amount of the transfer/transaction to the account of the recipient user (issued by the issuer institution 106B). The switch 114B and/or the transaction manager 116B cooperates, for example, with a settlement facilitator in Region B to coordinate settlement. The transaction manager 116B of Region B of the processing of the transfer/transaction (e.g., transfer cleared, transfer complete, appropriate accounts debited/credited, etc.) maintains one or more records, at 316, of the transaction life cycle, which includes the stages of clearing and settlement of the transaction, in memory (e.g., the memory 204, etc.). In this manner, the life cycle of the transfer is stored in memory of the transaction manager 116B, as permitted by the one or more rules.

In addition, at one or more times associated with clearing and/or settlement, the transaction manager 116A notifies the reporting device 118B, in Region B, at 318, of the transfer/transaction status/result, and the transaction manager 116B also notifies the service 110A, in Region A, at 320, of the transfer/transaction status/result. The service 110A is then permitted to close the transfer/transaction. Further, as shown in FIG. 3, the reporting device 118B then notifies the acquiring institution 104B of the transfer/transaction result, at 322, and notifies the issuer institution 106B of the transfer/transaction result, at 324. The institutions 104B, 106B then reconcile the amounts in/out of the respective accounts to the client 108A and the recipient user, indicative of clearing and settlement of the transfer, as coordinated by the processing network 102.

In view of the above, the systems and methods herein permit the distribution of processing of services across multiple different regions, whereby the services requested are processed in an appropriate region, regardless of the region in which the service request initiated. In this manner, the transfer/transaction, which is initiated in Region A is processed consistent with one or more applicable rules in Region B, and properly reported, whereby data restrictions associated with Region A and/or Region B are abided. What's more, the client is alleviated from having to know and/or maintain indications of the region in which the service requested is to be processed (i.e., the client is decoupled from the specific routing rules). Rather, the switch interface provides a single, consolidated entry point for service requests, for a given client or multiple clients, regardless of the region in which the service request is ultimately processed. Further still, the switch interface provides for real time or near real time of both the processing of the service request, and also notifications whereby the service and/or the client is informed of the region of processing.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and without limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving a service request from a client, via a service, in a first region; (b) determining a second region, based on the service request and at least one rule, the second region different than the first region; (c) based on the determined second region, directing the service request to a switch located in the second region; (d) transmitting, to the service, an indication of the second region, whereby the service is informed the service request is to proceed in the second region; (e) clearing and settling a transaction defined by the service request between the client and a recipient user; and/or (f) notifying a first institution of a completion of the transaction, the first institution including an issuer of an account to the client.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising.” “including.” and “having.” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

In addition, as used herein, the term product may include a good and/or a service.

Although the terms first, second, third, etc. may be used herein to describe be various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in providing a service across multiple regions, the method comprising:
receiving, by a switch interface computing device, a service request from a client, via a service, the switch interface computing device located in a first region;
determining, by the switch interface computing device, a second region, based on the service request and at least one rule, the second region different than the first region;
based on the determined second region, directing, by the switch interface computing device, the service request to a switch located in the second region; and
transmitting, by the switch interface computing device, to the service, an indication of the second region, whereby the service is informed the service request is to proceed in the second region.

2. The computer-implemented method of claim 1, wherein the service request includes a request to transfer funds from an account of the client to an account of a recipient user.

3. The computer-implemented method of claim 2, wherein the service request includes an account number of the account of the client;
wherein the at least one rule includes a link between the second region and a range of account numbers; and
wherein determining the second region based on the service request and the at least one rule includes determining the second region based on the account number of the account of the client being within the range of account numbers.

4. The computer-implemented method of claim 2, wherein the service request includes a loyalty rebate request; and
wherein the client is a merchant.

5. The computer-implemented method of claim 1, wherein the first region is defined by a country, and the second region is defined by a different country.

6. The computer-implemented method of claim 1, wherein determining the second region based on the service request and the at least one rule includes:
applying the at least one rule to the service request, the at least one rule based on a region of an acquiring institution and/or a currency code included in the service request; and
determining the second region based on the at least one rule.

7. The computer-implemented method of claim 6, wherein the at least one rule links the second region to an identifier associated with an account of the client and/or an institution, which issued the account to the client.

8. The computer-implemented method of claim 1, further comprising:
clearing and settling a transaction defined by the service request between the client and a recipient user; and
notifying a first institution of a completion of the transaction, the first institution including an issuer of an account to the client.

9. A system for use in providing a service across multiple regions, the system comprising:
a switch interface computing device including a processor, which is configured, by executable instructions, to:
receive a service request from a client, via a service, the switch interface computing device located in a first region;
determine a second region, based on the service request and at least one rule, the second region different than the first region;
based on the determined second region, direct the service request to a switch located in the second region; and
transmit, to the service, an indication of the second region, whereby the service is informed the service request is to proceed in the second region.

10. The system of claim 9, wherein the service request includes a request to transfer funds from an account of the client to an account of a recipient user.

11. The system of claim 10, wherein the service request includes an account number of the account of the client; and
wherein the processor is configured, by the executable instruction, in order to determine the second region based on the service request and the at least one rule, to determine the second region further based on the account number of the account of the client.

12. The system of claim 9, wherein the service request includes a loyalty rebate request; and
wherein the client is a merchant.

13. The system of claim 9, wherein the first region is defined by a country, and the second region is defined by a different country.

14. The system of claim 9, wherein the processor is configured, by the executable instructions, in order to determine the second region based on the service request and the at least one rule, to:
apply the at least one rule to the service request, the at least one rule based on a region of an acquiring institution and/or a currency code included in the service request; and
determine the second region based on the at least one rule.

15. The system of claim 9, wherein the at least one rule links the second region to an identifier associated with an account of the client and/or an institution, which issued the account to the client.

16. The system of claim 9, further comprising a processing network including the switch interface computing device; and
wherein the processing network is configured to:
clear a transaction defined by the service request between the client and a recipient user; and
notify a first institution of the cleared transaction, the first institution including an issuer of an account to the client.

17. The system of claim 9, wherein the switch interface computing device is further configured, by executable instructions, to:
receive a second service request from a second client, via the service;
determine a third region, based on the second service request and at least one other rule, the third region different than the first region and the second region;
based on the determined third region, direct the second service request to a switch located in the third region, rather than the switch located in the second region; and
transmit, to the service, an indication of the third region, whereby the service is informed the second service request is to proceed in the third region.

18. A non-transitory computer-readable storage medium comprising executable instructions, which when executed by at least one processor of a switch interface computing device, cause the at least one processor to:
receive a service request from a client, via a service, the switch interface computing device located in a first region;
determine a second region, based on the service request, the second region different than the first region;
based on the determined second region, direct the service request to a switch located in the second region; and
transmit, to the service, an indication of the second region, whereby the service is informed the service request is to proceed in the second region.
